(19) United States
(12) Patent Application Publication
(10) Pub. No.: US 2025/0019578 A1
(43) Pub. Date: Jan. 16, 2025

(54) ACRYLIC COPOLYMER COMPOSITIONS FOR USE AS SEALANTS

(71) Applicant: ROHM AND HAAS COMPANY, Collegeville, PA (US)

(72) Inventors: Kimy YEUNG, Phoenixville, PA (US); Audrey LISS, Newtown, PA (US); Mark WESTMEYER, Collegeville, PA (US)

(21) Appl. No.: 18/711,271

(22) PCT Filed: Oct. 25, 2022
(86) PCT No.: PCT/US2022/047655

§ 371 Date: May 17, 2024

Related U.S. Application Data
(60) Provisional application No. 63/287,182, filed on Dec. 8, 2021.

(51) Int. Cl. C09J 133/06; C08F 220/18; C09J 5/00

(52) U.S. Cl. CPC C09J 133/066; C08F 220/1804; C09J 5/00

(57) ABSTRACT

An aqueous composition comprises a filler and a dispersion of multi-stage polymer particles. The particles have a first stage formed from non-ionic ethylenically unsaturated monomers and ethylenically unsaturated acid functional monomers polymer and a second stage, formed from 85-98.5 weight % non-ionic ethylenically unsaturated monomers, 1-15 weight % of ethylenically unsaturated acid functional monomers, and either (i) 0.01-0.5 weight % a non-silane functional chain transfer agent and 0.4-2 weight % of an ethylenically unsaturated silane functional monomer or (ii) 0.01-0.5 weight % of a silane functional chain transfer agent and 0-2 weight % of an ethylenically unsaturated silane functional monomer based on total weight of monomers and chain transfer agent in the second stage. The weight ratio of the first stage to the second stage is 1:1 to 9:1. The weight ratio of filler to polymer particles is 0.01:1 to 2:1. The composition can form sealants that meet ASTM C920 class 50.

### CROSS REFERENCE TO RELATED APPLICATIONS

This application claims the benefit of U.S. Application No. 63/287,182, filed on Dec. 8, 2021, which is incorporated herein by reference in its entirety.

### FIELD OF THE INVENTION

The field of this invention is acrylic copolymer compositions and their use as sealants.

### BACKGROUND

Sealants (e.g., caulks) are materials used to fill and seal joints such as between building materials. The sealants are typically waterproof and at least water resistant. When selecting a sealant, one or more of the following properties can be important: movement tolerance; substrate compatibility; workability, particularly based on temperature; paintability and its converse-substrate staining; relative cost; service life; and material constituency and hazardous content. Common classes of sealants include silicone based sealants, butyl sealants, polysulfide sealants, and polyurethane sealants. Another class—acrylic and or acrylic latex sealants—can provide good durability, paintability and ease of use. However, they can have more limited movement tolerance than certain other types of sealants.

ASTM C920-18 “Standard Specification for Elastomeric Joint Sealants” is an accepted industry standard for measuring movement capacity. This test specifies a rating system, by class, which has been commonly adopted by the sealant industry. The class of the sealant is the % of compression and extension the sealant tolerates before undergoing failure due to cracking or loss of adhesion. For example, a sealant that meets Class 25 will withstand 25% extension and 25% compression, under the ASTM test conditions. Higher class sealants, such as class 50 (withstanding 50% extension and 50% compression) are used in the most demanding applications.

### SUMMARY OF THE INVENTION

Disclosed herein is an aqueous composition useful as a sealant comprising (a) an aqueous polymer dispersion comprising water and at least 50 weight % (wt. %) polymer particles based on total weight of the aqueous polymer dispersion where the polymer particles are made by polymerizing, in a first stage, monomers comprising 85 to 99 weight % non-ionic ethylenically unsaturated monomers and 1 to 15 weight % of ethylenically unsaturated acid functional monomers, where the weight % for each is based on total weight of monomers in the first stage to form a first stage polymer followed by continuing polymerizing, in a second stage, reactants comprising 85 to 98.5 weight % non-ionic ethylenically unsaturated monomers, 1 to 15 weight % of ethylenically unsaturated acid functional monomers, and either (i) 0.01 to 0.5 weight % a non-silane functional chain transfer agent and 0.4 to 2 weight % of an ethylenically unsaturated silane functional monomer or (ii) 0.01 to 0.5 weight % of a silane functional chain transfer agent and 0 to 2 weight % of an ethylenically unsaturated silane functional monomer based on total weight of monomers and chain transfer agent in the second stage to form a second stage polymer, wherein the weight ratio of the first stage to the second stage is 1:1 to 9:1, and (b) filler, wherein the weight ratio of filler to polymer particles is 0.01:1 to 2:1 based on dry weight of filler and polymer.

Also disclosed herein is an aqueous sealant composition comprising (a) a silane functionalized acrylic emulsion polymer and (b) filler in a weight ratio of the filler to the polymer of 0.01:1 to 2:1 based on dry weight of filler and polymer, wherein the composition after coating and cure meets ASTM C920-18 class 50 requirements.

### DETAILED DESCRIPTION OF THE INVENTION

Disclosed herein is a sealant composition comprising (a) an aqueous silane functionalize acrylic polymer emulsion and (b) filler. Disclosed herein is a water-based acrylic sealant composition which shows joint movement capability after 10 cycles of 50% compression and 50% extension pursuant to ASTM C719 with less than or equal to 9 square centimeters (cm²) total bond loss. Also disclosed herein is a water-based acrylic sealant composition which meets ASTM C920-18 class 50 requirements.

### Silane Functionalized Acrylic Polymer

The silane functionalized acrylic polymer used in the composition of this invention is a two stage acrylic polymer dispersion.

The first stage comprises the polymerized product of one or more ethylenically unsaturated non-ionic monomers copolymerized with one or more acid functional ethylenically unsaturated monomers. The first stage can, optionally, include an ethylenically unsaturated silane functional monomer. Alternatively, the first stage can be free of ethylenically unsaturated silane functional monomers. The first stage can be free of chain transfer agent.

The amount of ethylenically unsaturated non-ionic monomer in the first stage can be from 85, from 90, from 95, or from 96 weight % up to 99 weight % based on total weight of monomers in the first stage. The amount of acid functional ethylenically unsaturated monomers can be from 1 weight % up to 15, up to 10, up to 5 or up to 4 weight % based on total weight of monomers in the first stage. To achieve desired functional Tg of the polymer particles 90% or more the monomers used in the first stage can be those having a Fox Tg of no more than −20° C. If a silane functional monomer is used in the first stage, it is preferably present in an amount less than 1 or less than 0.5 weight %.

The copolymers may be made via conventional emulsion polymerization methods. In the polymerization, known emulsifiers and/or dispersants may be used such as, for example, anionic and/or nonionic emulsifiers such as, for example, alkali metal or ammonium salts of alkyl, aryl, or alkylaryl sulfates, sulfonates or phosphates; alkyl sulfonic acids; sulfosuccinate salts; fatty acids; ethylenically unsaturated surfactant monomers; and ethoxylated alcohols or phenols. The amount of surfactant used is usually 0.1% to 6% by weight, based on the weight of monomer. Either thermal or redox initiation processes may be used. The reaction temperature may be maintained at a temperature lower than 100° C. throughout the course of the reaction, preferably from 30° C. to 95° C. The monomer mixture may be added neat or as an emulsion in water. The monomer mixture may be added in one or more additions, such as in a shot or multiple shot polymerization, or semi-continuously, e.g., via gradual addition methods, either linearly or not linearly, over the reaction period, or any combination thereof.

Conventional free radical initiators may be used such as, for example, hydrogen peroxide, t-butyl hydroperoxide, cumene hydroperoxide, ammonium and/or alkali metal persulfates, perborate salts and, perphosphoric acid and salts thereof, potassium permanganate, and ammonium or alkali metal salts of peroxydisulfuric acid, at levels of 0.01 to 3.0 wt. %, based on the total weight of monomer. Redox systems using such initiators coupled with a suitable reductant such as, for example, sodium sulfoxylate formaldehyde (SSF); (iso) ascorbic acid; alkali metal and ammonium salts of sulfur-containing acids, such as sodium sulfite, bisulfite, thiosulfate, hydrosulfite, (hydro) sulfide, or dithionite; sulfinic acids or their salts; amines such as ethanolamine; weak acids such as glycolic acid, lactic acid, malic acid, tartaric acid and salts thereof. In addition, redox reaction catalyzing metal salts, such as those of iron, copper, nickel, or cobalt may be used.

Seed latex particles can be used. For example, the monomers may be addition polymerized in the presence of one or more aqueous dispersion of a seed polymer made from addition polymerizable monomers having a very small average particle size, e.g., 100 nm or less, or 50 nm or less. The copolymers can be formed in dual or multiple seed copolymerization wherein a single shot or gradual addition (feed) of monomers is polymerized in the presence of a seed latex shot, and a second or multiple additional seed latex particles are added later in one or more separate shots.

After the first stage of polymerization (e.g., after 50-90, 60-80, or 70-75 weight % of the monomers have been fed into the polymerization mixture based on total weight of the monomers for the entire polymer) the second stage is initiated by adding an ethylenically unsaturated silane functional monomer and a non-silane chain transfer agent or by adding a silane functional chain transfer agent to the feed. The feed of the ethylenically unsaturated non-ionic monomers and ethylenically unsaturated acid functional monomers can continue during the second stage. The second stage can form a partial shell around the first stage. The second stage can form a substantially complete shell around the first stage. During the second stage, ethylenically unsaturated non-ionic monomers and ethylenically unsaturated acid functional monomers will be present and will polymerize with any ethylenically unsaturated silane functional monomer added during the second stage and react with the chain transfer agent.

The amount of ethylenically unsaturated non-ionic monomer in the second stage can be from 85, from 90, from 95 weight % up to 98.5 weight % based on total weight of monomers and chain transfer agent in the second stage. The amount of acid functional ethylenically unsaturated monomers in the second stage can be from 1 weight % up to 15, up to 10, up to 5, or up to 4 weight % based on total weight of monomers and chain transfer agent in the second stage. If a silane functional chain transfer agent is used in the second stage, the amount of ethylenically unsaturated silane functional monomer can be 0, or from 0.01, from 0.05 up to 2, up to 1.5 or up to 1 weight % based on total weight of monomers and chain transfer agent in the second stage. If a non-silane functional chain transfer agent is used in the second stage, the amount of ethylenically unsaturated silane functional monomer can be from 0.4, from 0.6, or from 0.8 up to 2, or up to 1 weight % based on total weight of monomers and chain transfer agent in the second stage. The amount of chain transfer agent can be 0.01 up to 0.5 weight % based on total weight of monomers and chain transfer agent in the second stage.

The first stage of the polymer can comprise 50-90 weight % of the polymer while the second stage can comprise 10 to 50 weight % of the polymer.

Examples of non-ionic ethylenically unsaturated monomers include alkyl acrylates and alkyl methacrylates (sometimes referred to herein as alkyl (meth)acrylates designating the “meth” as optional), hydroxy substituted alkyl (meth)acrylates (e.g., hydroxyethyl methacrylate), styrenic monomers (e.g., styrene and methyl styrene), and acrylonitrile monomers (e.g., acrylonitrile, methacrylonitrile). The non-ionic ethylenically unsaturated monomers can be acrylate monomers only or, optionally in combination with some styrenic monomer and/or acrylonitrile monomers. The acrylic monomers can comprise 50% or more of the non-ionic ethylenically unsaturated monomers. Examples of alky acrylates, alkyl methacrylates and hydroxy substituted alkyl (meth)acrylates are 2-ethylhexyl acrylate, butyl acrylate, ethyl methacrylate, methyl acrylate, 2-hydroxyl acrylate, 4-hydroxybutyl acrylate, lauryl acrylate, tert-butyl acrylate, methyl methacrylate, ethyl methacrylate, butyl methacrylate, isobutyl methacrylate, ethylhexyl (meth)acrylate, n-heptyl (meth)acrylate), ethyl(meth)acrylate, 2-methylheptyl (meth)acrylate, octyl (methyl)acrylate, isooctyl (meth)acrylate, n-nonyl (meth)acrylate, isononyl (meth)acrylate, n-decyl (meth)acrylate, isodecyl (meth)acrylate, dodecyl (meth)acrylate, lauryl (meth)acrylate, tridecyl (meth)acrylate, stearyl (meth)acrylate, glycidyl (meth)acrylate, alkyl crotonates, di-n-butyl maleate, di-octylmaleate, acetoacetoxyethyl(meth)acrylate, acetoacetoxypropyl (meth)acrylate, hydroxyethyl(meth)acrylate, allyl (meth)acrylate, tetrahydrofurfuryl (meth)acrylate, cyclohexyl (meth)acrylate, 2-ethoxyethyl(meth)acrylate, 2-methoxy (meth)acrylate, 2-(2-ethoxy-ethoxy)ethyl(meth)acrylate, 2 ethylhexyl acrylate, 2-propylheptyl (meth)acrylate, 2-phenoxyethyl(meth)acrylate, polypropyleneglycol mono(meth)acrylate, polyethyleneglycol (meth)acrylate, benzyl (meth)acrylate, 2,3-epoxycyclohexylmethyl(meth)acrylate, hydroxypropyl (meth)acrylate, methylprolyglycol (meth)acrylate, 3,4-epoxycyclohexylmethyl(meth)acrylate, 1,6 hexanediol di(meth)acrylate, 1,4 butanediol di(meth)acrylate and for copolymer, and combinations thereof.

Examples of acid functional ethylenically unsaturated monomers are ethylenically unsaturated carboxylic acid functional monomers, ethylenically unsaturated sulfur acid functional monomers, ethylenically unsaturated phosphorous acid functional monomers, or a combination or two or more of acid functional ethylenically unsaturated monomers. Specific carboxylic acid containing monomers may include, for example, acrylic acid, and methacrylic acid, itaconic acid (IA), maleic acid (MA), and fumaric acid (FA), and salts thereof. Suitable sulfur acid containing monomers may include, for example, styrene sulfonate and acrylamidopropane sulfonate and their salts. Suitable phosphorus containing acids may include, for example, any phosphorus containing acids possessing at least one POH group in which the hydrogen atom is ionizable, and their salts, such as phosphoalkyl (meth)acrylates like 2-phosphoethyl methacrylate (PEM), di-, tri-, or poly-phosphate ester group containing (meth)acrylates; alkylvinyl phosphonates and their salts; monomers containing groups formed from phosphinic acid, phosphonic acid, phosphoric acid, pyrophosphinic acid, pyrophosphoric acid, partial esters thereof, and salts thereof.

Optional additional monomers include vinyl esters of vinyl halides such as vinyl chloride, an alkanoic acid with 1 C to 12 C-atoms with non-limiting examples including vinyl acetate, vinyl propionate, vinyl valerate, vinyl 2-ethylhexanoate, vinyl laurate, vinyl versatates, and mixtures thereof. Vinyl versatates may include vinyl esters of alpha-branched monocarboxylic acids, for example VeoVa 9® or VeoVa 10® (tradenames of Momentive), which have 9 C- and 10 C-atoms, respectively, in the carboxylic acid moiety. A preferred vinyl ester monomer can be vinyl acetate. The vinyl ester monomer (a) may be copolymerized in general in an amount of from 0 percent by weight (or weight-percent [wt %]) to 20 wt % in one embodiment, and from 0 wt % to 10 wt % in another embodiment, based on the total weight of the monomers.

The ethylenically unsaturated silane monomer can be represented by the general formula: R′—Si(—OR)₃₋ₓ(—Me)ₓ, wherein R′ represents a functional group selected from any substituted or unsubstituted, ethylenically unsaturated hydrocarbyl group, preferably of 2 to 5, more preferably 2 to 4, and most preferably 2 to 3 carbon atoms, and R is either a branched or linear alkyl group of 1 to 18, preferably 1 to 5 carbon atoms, preferably selected from methyl, ethyl, propyl, isopropyl, butyl and tert-butyl; and x is an integer from 0 to 3.

Examples of suitable ethylenically unsaturated silane functional monomers include alkylvinyldialkoxysilanes; vinyltrialkoxysilanes such as vinyltriethoxysilane (VTES) and vinyltrimethoxysilane (VTMS); (meth)acryloxyalkyltrialkoxysilanes including (meth)acryloxyethyltrimethoxysilanes, (meth)acryloxypropyltrimethoxysilanes (MATS) such as gamma-methacryloxypropyltrimethoxy silane, methacryloxypropyltriethoxysilane methacryloxypropyl triethoxysilane, 3-acryloxypropyl trimethoxysilane, and methacryloxyethyl trimethoxysilane; and (meth)acryloxyalkyldialkoxysilanes such as 3-methacryloxypropyl methyldimethoxysilane, 3-methacryloxypropyl methyldiethoxysilane,; derivatives thereof; or combinations thereof. Commercially available ethylenically unsaturated silane functional monomers include SILQUEST A-174, A-171, A-151, A-2171 andA-172E, and Coatosil-1706, Coatosil-1757 and Y-11878 silanes all available from Momentive Performance Materials, or mixtures thereof.

Examples of non-silane chain transfer agents are mercaptan functional compounds such as n-dodecyl mercaptan (nDDM), tert-dodecyl mercaptan, methyl-3-mercaptopropionate, butyl-3-mercaptopropionate, i-octyl-3-mercaptopropionate, i-decly-3-mercaptopropionate, dodecyl-3-mercaptopropionate, octadecyl-3-mercaptopropionate, 2-ethyl hexyl-3-mercaptopropionate, and mercaptopropionic acid.

The silane functional chain transfer agents can have the formula Z—CH₂CH₂CH₂—Si(—OR)₃₋ₓ(—Me)ₓ, wherein Z is an unbranched or branched, or linear aliphatic hydrocarbon with a heteroatom such as O, N or S. Z is a mercapto (—SH); R is either a branched or linear alkyl group of 1 to 18, preferably 1 to 5 carbon atoms, preferably selected from methyl, ethyl, propyl, isopropyl, butyl and tert-butyl; and x is an integer from 0 to 3.

Examples of such silane functional chain transfer agents include: mercaptoalkylalkoxysilanes, such as mercaptopropyltrialkoxysilane (MPTAS).

The polymer can be present as particles in water. The polymer can comprise 50-80, 55-75, or 60-65 weight % of the aqueous emulsion polymer composition.

The polymer can have Tg as determined by differential scanning calorimetry (DSC) as set forth herein of −60 to −30° C. The first stage polymer can have a calculated Tg using the Fox equation of −60 to −30° C. See e.g., Fox, Bull. Am. Phys. Soc. 1, 123 (1956).

The polymer can have an average particle size in the range of 70 nanometers (nm) to 1 micrometer (μm). The particle size distribution can be unimodal or multimodal (i.e., showing one peak or two peaks (bimodal) or more than two peaks.) Particle size and distribution can be determined using Capillary Hydrodynamic Fractionation as set forth herein. The bimodal or multimodal distributions can be produced by any known method such as, for example, as is described in U.S. Pat. No. 4,130,523.

### Sealant Composition

In addition to the aqueous emulsion polymer composition, the sealant composition comprises filler (e.g., pigment). The weight ratio of the weight of filler to the weight of the polymer can be at least 0.01:1 or at least 0.03:1 up to 2:1, up to 1.5:1, up to 1:1, up to 0.5:1, up to 0.2:1, or up to 0.1:1.

The aqueous caulk or sealant compositions may be prepared by techniques which are well known in the sealants art. For example, the aqueous binder is added directly to a kettle, followed by additional ingredients and, lastly, by the filler. Mixing may be done in a high shear mixer with a sweep arm designed to pull the high viscosity sealant into the center of the mixer, or in a planetary mixer, with or without a high speed disperser blade. After all of the ingredients are added, the sealant is allowed to mix under a vacuum of 750 millimeters (mm) Hg or lower to remove entrapped air from the final product.

Suitable fillers may include, for example, alkaline earth metal sulfates or carbonates, such as, for example, barites, calcium carbonate, calcite and magnesium carbonate; silicates, such as, for example, calcium silicates, magnesium silicates, and talc; metal oxides and hydroxides, such as, for example, titanium dioxide, alumina and iron oxides; diatomaceous earth; colloidal silica; fumed silica; carbon black; white carbon black; nutshell flour; natural and synthetic fibers (especially plaster fibers); and scrap or recycled plastics in the form of dust, flakes or flour; hollow or solid ceramic, glass or polymeric microspheres. The filler can comprise pigment.

The sealant composition can further comprise additional water in amounts up to 10% based on total weight of the composition. The total amount of water in the composition (including water in the aqueous dispersion and as solvent for any other ingredients) can be 20 to 50, 25-40, or 30-35 weight percent.

To enable improved adhesion, especially to glass, the caulks and sealants may comprise one or more organosilane adhesion promoter in amounts ranging from 0.001 to 5 wt. %, based on the total weight of the composition, preferably, 0.01 wt. % or more, or, preferably, up to 1.0 wt. %, or, more preferably, up to 0.5 wt. %.

Suitable organosilanes may include, for example, any hydrolyzable or alkoxy functional organosilanes, such as, for example, trialkoxysilanes; aminoalkylsilanes or aminoalkoxysilanes, such as γ-aminopropyl triethoxysilane and N-(dimethoxymethylsilylisobutyl) ethylenediamine; epoxy functional alkoxysilanes, such as glycidyl propoxymethyl dimethoxysilane, γ-glycidoxypropyl-methyl-diethoxysilane, γ-glycidoxypropyl trimethoxysilane, and β-(3,4-epoxycycyclohexyl)ethyl trimethoxysilane; (meth)acryloyl alkoxysilanes, such as γ-methacryloxypropyl trimethoxysilane; vinyltriethoxysilane, and γ-mercaptoalkoxysilanes.

To enable improved filler dispersion and uniformity in the composition, the aqueous caulks and sealants may comprise one or more dispersant which can be an organic dispersant, e.g., a carboxylic acid (co) polymer, such as poly(methacrylic acid), or inorganic dispersant, such as alkali (ne) metal salts of tripolyphosphates, metaphosphates and their salts, and hexametaphosphates and their salts. Suitable amounts of dispersants may range from 0.01 to 5 wt. %, based on the total weight of the composition, preferably, 0.02 to 2 wt. %, or, more preferably, 0.1 to 1.0 wt. %.

Solvents may be added to improve tooling in use, increase open time (storage stability) and to better disperse additives, such as the silanes. Suitable solvents may include, for example, mineral spirits, turpentine, mineral oil, and (poly)alkylene glycols.

The compositions of the present invention may also include other additives conventionally employed in caulks and sealants, such as, for example, freeze-thaw stabilizers (in amounts, for example, of 0 to 2.5, or 0.1 to 2.3 weight percent), drying oils, biocides (in amounts, for example of 0 to 0.2, or 0.05 to 0.15 weight percent), rheology modifiers or thickeners (in amounts for example of 0 to 2 or 0.1 to 1.5 weight percent), such as cellulosics, kaolin, polyacrylic acids and polyurethane thickeners, antifoamants (defoamers) (in amounts such as 0 to 1 or 0.05 to 0.5 weight percent), colorants, waxes and anti-oxidants. Generally, the weight of these other additives is 0 to 10 or 0.1 to 5 weight percent. The weight percents are based on total weight of the composition.

Surfactants and emulsifiers commonly used in emulsion polymerization may be present. These include anionic, nonionic, and cationic surfactants, such as, for example, non-ionic surfactants, like alkylphenol ethoxylates (APEO) or APEO-free surfactants. In one embodiment, surfactants can be added to the latices during synthesis as post additives.

The total percentages of all the components of the aqueous composition (e.g., polymer dispersion, filler, water, adhesion promoter, solvent, additives, surfactants, emulsifiers) add up to 100%. The composition can comprise 50-70 percent solids by weight with the remainder being water or other liquid components such as solvents, surfactants or emulsifiers.

### Use and Performance

The compositions of the present invention are suitable for uses including caulks, sealants and construction adhesives, such as by applying the caulk and sealant to a substrate from a cartridge and allowing it to dry. Caulks and sealants can be applied to various substrates including wood, glass, metal, masonry, vinyl, brick, concrete block, fiber cement, gypsum, stone, tile and asphalt. Uses may include caulking and sealing windows, doors, fixtures, paneling, molding, finished walls and ceilings, and any gap, seam or joint therein or between substrate pieces, such as in tilt-up construction and chinking applications.

The sealant compositions disclosed herein can meet ASTM C920-18 class 50. The sealant compositions can show less than 9 cm² bond loss joint movement capability pursuant to ASTM C719 as described herein. More specifically, on glass, aluminum and mortar tested according to ASTM C719 the sealant compositions can show less than 5 cm² bond loss at room temperature and less than 7 cm² bond loss at −26° C.

Preferred versions of the sealant compositions can show wet peel adhesion of no greater than 25% bond loss at greater than 22 Newtons (N) force pursuant to ASTM C794-18.

### EXAMPLES

### Test Methods

### Dispersion Characterization:

### Capillary Hydrodynamic Fractionation

Capillary hydrodynamic fractionation (CHDF) experiments can be conducted on the Matec CHDF3000 with a GP instrument autosampler. The system is calibrated with standards ranging from 40 nm to 800 nm. Standards are also prepared using the carrier fluid. Table 1 below summarizes the instrument condition and method. A sample is prepared by mixing 8 drops of polymer dispersion with 3 mL of the carrier fluid (GRX500). The resulting mixture is then filtered through nylon 1.5 mm filter prior to injection. Particle sizes are reported by the peak values along with the weight area %.

TABLE 1
CHDF Method Conditions

| | |
|---|---|
| Mobile Phase | GR 500 |
| Column | C-202, S/N 950, Temperature at 35° C. |
| Flow Rate | 1.2 mL/min, pressure 4800 psi |
| Detector | UV @ 220 nm |
| Runtime | 15 min |
| Marker | 0.15% Sodium Benzoate |

### Differentiating Scanning Calorimetry

Differentiating scanning calorimetry (DSC) experiments were conducted on the TA instruments Q1000 DSC with RCS and Discovery 2500 with RCS. Samples were prepared by adding ≤10 mg polymer dispersion into an aluminum pan. The pan was left to dry in a 60° C. oven for at least 24 hours. The pan was then sealed with an aluminum lid and submitted for thermal analysis. The following method was used to analyze the polymer dispersion:
1. Ramp 20.00° C./min to 150.00° C. (end of cycle 1)
2. Isothermal hold for 2.00 min
3. Equilibrate at −80.00° C. or −90.00° C.
4. Isothermal hold for 2.00 min (mark end of cycle 2)
5. Ramp 20.00° C./min to 150.00° C.
6. Turn on air cool (end of method)

The Tg was determined by the midpoint between the onset and endpoint of the transition curve.

### Joint Movement (ATSM-C719-14):

Sealant joint movement capability can be evaluated according to ASTM C-719, Standard Test Method for Adhesion and Cohesion of Elastomeric Joint Sealants under Cyclic Movement. Three 2.0″×0.5″×0.5″ (5.08 cm×1.27 cm×1.27 cm) H-block specimens are prepared on glass, aluminum and concrete mortar substrates. Samples are cured for one week at 23° C. (50% relative humidity), cured for an additional 2 weeks at 50° C., and then soaked in water for one week. The joints are then compressed by 50% from the initial joint width and then placed in a 70° C. oven for one week. The specimens are then subjected to ten ±50% joint movement cycles at room temperature (23° C.) (50% RH) at a rate of 0.125 in/hr (0.3175 cm/hour). In addition, specimens are subjected to ten low temperature cycles (50% compression at 70° C., followed by 50% extension at −26° C.) at a rate of 0.125 in/hr (0.3175 cm/hour). The amount of failure (total adhesive plus cohesive failure in square centimeters of the three specimens) is reported. Joint movement testing results are reported as Pass (P) or Fail (F). A material passes if less than or equal to 9 cm² total bond loss is observed for the combination of the three specimens after the full number of cycles. More detailed Pass results can be indicated by No Failure (NF) or the combined amount of adhesive plus cohesive failure in cm². More detailed Fail results can include where in the test failure occurred: during the water soak (H2O), during the room temperature cycling (RT) or after the number of low temperature cycles; or the combined amount of adhesive plus cohesive failure in cm².

### Adhesion (ASTM-C794-18):

Peel adhesion can be measured according to the ASTM C794-18, Standard Test Method for Adhesion-in-Peel of Elastomeric Joint Sealants. Specimens are prepared by embedding two 1 inch (2.54 cm) wide strips of wire screen into a 0.125 inch (0.3175 cm) thick layer of sealant on two of each 3″×6″ (7.62×15.24 cm) glass, aluminum and concrete mortar substrates, and cured for one week at 23° C. (50% RH) followed by two weeks at 50° C. Peel adhesion is then measured by peeling the embedded screen back from the substrate at 180° in a Tinius Olsen tensile tester at 2″/min (5.08 cm/minute). The force required to peel the sealant from the substrate was measured (N) and the type of failure mode is noted as Cohesive (C) or Adhesive (A). Two dry peel adhesion measurements on each of the three substrates were made after the initial three-week cure. Two wet peel adhesion measurements on each of the three substrates were made after an additional 1 week of water soak.

### Materials

TABLE 2
Materials for Polymer Dispersion and Sealant

| | Abbre- | | |
|---|---|---|---|
| | viation | Use | Supplier |
| sodium dodecyl | SDS | Surfactant | Stepan |
| benzene sulfonate | | | |
| (Polystep ™ A-16-22) | | | |
| Disodium 4-(2- | n/a | Surfactant | Solvay |
| (dodecyloxy)ethyl) 2- | | | |
| sulphonatosuccinate | | | |
| (Aerosol ™ A-102) | | | |
| Octylphenol Ethoxylate | n/a | Surfactant | Dow Chemical |
| 70% in water | | | |
| (Triton ™ X-405, | | | |
| CAS# 9036-19-5) | | | |
| glacial acrylic acid | AA | Acid Monomer | Dow Chemical |
| Butyl acrylate | BA | Monomer | Dow Chemical |
| 2-ethylhexyl acrylate | EHA | Monomer | Dow Chemical |
| 2-hydroxyethyl | HEMA | Monomer | Dow Chemical |
| methacrylate | | | |
| Methacrylic acid | MAA | Acid Monomer | Dow Chemical |
| Methyl methacrylate | MMA | Monomer | Dow Chemical |
| Trimethoxyvinylsilane | VTMS | Silane | Sigma Aldrich |
| CAS# 2768-02-7 | | monomer 1 | |
| 3-(Trimethoxysily1)propyl | MATS | Silane | Sigma Aldrich |
| methacrylate | | monomer 2 | |
| Ammonium persulfate | APS | Initiator | Sigma Aldrich |
| tert-butyl | TBHP | Initiator | Acros Organics |
| hydroperoxide (70% | | | |
| solution in water) | | | |
| (3-Mercaptopropyl) | MPTMS | Chain | Sigma Aldrich |
| trimethoxysilane | | transfer agent | |
| CAS# 4420-74-0 | | | |
| n-dodecyl mercaptan | nDDM | Chain | Sigma Aldrich |
| CAS# 112-55-0 | | transfer agent | |
| ammonium hydroxide | — | Neutralizer | Sigma Aldrich |
| 29% solution | | | |
| in water | | | |
| ferrous sulfate heptahydrate | — | Promoter | Sigma Aldrich |
| Bruggolite ™ FF6M | FF6 | Activator | Brueggemann |
| sodium formaldehyde | SFS | Activator | Sigma Aldrich |
| sulfoxylate | | | |
| Kathon ™ LX 1400 | — | Biocide | DuPont |
| Kathon ™ LX 1.5 | — | Biocide | DuPont |
| Skane ™ M-8 | — | Biocide | Dupont |
| Ethylene Glycol | — | Humectant | Acros Organics |
| Ethyl cellulose | HEC | Rheology | SE Tylose |
| Tylose HS 100000 YP | | Modifier | GmbH & |
| | | | Co. KG |
| White Mineral Oil | — | Plasticizer | Palmer |
| Semtol ™ 500 | | | Holland |
| Glycidoxypropyl- | A-187 | Adhesion | Momentive |
| trimethoxysilane | | Promoter | |
| Momentive A-187 Silane | | | |
| Untreated Fumed Silica | | Inorganic | Cabot |
| CAB-O-SIL ™ M-5 | | Filler | |
| calcium carbonate Drikalite | CaCO₃ | Inorganic | Imerys |
| | | Filler | |
| Rutile Titanium Dioxide | TiO₂ | Pigment | Chemours |
| Ti-Pure R-900 | | | |

### Polymer Dispersion Syntheses

Polymer A—Multistage Polymer with No Silane Monomer or Silane Functional Chain Transfer Agent(Comparative)

To a 5-L, four-necked round bottom flask (kettle) equipped with a paddle stirrer, thermometer, N2 inlet, and reflux condenser is added deionized water (DI) (425.0 g) and the kettle is heated to 89° C. under N₂. Two monomer emulsions are prepared: ME1 and ME2. ME1 is prepared by mixing DI water (77.6 g), sodium dodecyl benzene sulfonate (SDS, 22.5%, 5 g), Aerosol A-102 (32%, 9.16 g) butyl acrylate (73.58 g), methyl methacrylate (288.78 g), glacial acrylic acid (5.52 g), and n-dodecyl mercaptan (3.68 g). ME2 is prepared by mixing DI water (418.8 g), SDS (31.92 g), Aerosol A-102 (15.48 g), 2-ethylhexyl acrylate (462.46 g), butyl acrylate (1387.38 g), methyl methacrylate (39.34 g), 2-hydroxyethyl methacrylate (38.36 g), methacrylic acid (9.84 g) and glacial acrylic acid (29.5 g). When the kettle temperature has reached 89° C., a solution of ammonium persulfate (98%, 1.9 g) in DI water (16.6 g) is added to the kettle, followed by a DI water rinse (4.2 g). A BA/MMA/MAA latex seed having a particle size of 100 nm (36.72 g) is added, followed by a DI water rinse (17.0 g). With the kettle temperature at 81-84° C., ME1 is fed to the kettle at 10.28 g/min over 15 min with the temperature set to 85° C. Simultaneously, a solution of ammonium persulfate (7.54 g) in DI water (95.6 g) is cofed at a rate of 0.516 g/min over 15 min. After 15 min, the monomer emulsion feed rate is increased to 32.56 g/min and the cofeed catalyst feed rate is increased to 1.032 g/min over 15 min. After the completion of ME1, DI water rinse (29.2 g) is added. After rinse, ME2 is fed to the kettle at 32.56 g/min over 75 min. After 31 min from the start of ME2 feed, a BA/MMA/MAA latex seed having a particle size of 60 nm (56.88 g) is added to the kettle, followed by a DI water rinse (16.6 g). After 54 min from the start of ME2 feed, n-dodecyl mercaptan (0.88 g) is added to the monomer emulsion, followed by a DI water rinse (8.2 g). After completion of the additions of ME2 and cofeed catalyst, followed by a DI water rinse (78.8 g), the kettle is cooled to 75° C. over 15 min. At 80° C. or below, ammonium hydroxide solution (30%, 3.44 g) is added to the kettle, followed by a DI water rinse (4.2 g). A solution of ferrous sulfate heptahydrate (0.15% solution, 8.5 g) is added to the kettle, followed by tert-butyl hydroperoxide (70% solution, 0.72 g) in DI water (8.2 g). A solution of Bruggolite FF6M (0.49 g) in DI water (20.0 g) is fed to the kettle at 1.366 over 15 min. After completion, the kettle is cooled to 55° C. At 70-75° C., a second solution of tert-butyl hydroperoxide (3.64 g) in DI water (4.2 g) is added to the kettle. A second solution of FF6M (2.39 g) in DI water (3.02 g) is then fed to the kettle at 1.38 g/min over 25 min. After completion of the Bruggolite FF6M solution, the reaction mixture is cooled to room temperature and filtered to remove any coagulum. A filtered product had a pH of 4.17, a solids content of 63.7%, and a viscosity of 170.7 centipoise (cP) (LV #2/60 rpm). DSC analysis indicated a midpoint of −46.83° C.; particle size analysis using capillary hydrodynamic fractionation (CHDF) technique indicated a particle size distribution based on weight area % of 115.8 (1.3%), 397.9 (71%), and 465.3 (27.7%).

### Polymer B

To a 5-L, four-necked round bottom flask (kettle) equipped with a paddle stirrer, thermometer, N2 inlet, and reflux condenser is added deionized water (DI) (443.59 g) and the kettle is heated to 89° C. under N2. A monomer emulsion is prepared by mixing DI water (504.56 g), sodium dodecyl benzene sulfonate (SDS, 22.5%, 37.72 g), Aerosol A-102 (32%, 17.68 g), 2-ethylhexyl acrylate (557.07 g), butyl acrylate (1665.41 g), methyl methacrylate (47.94 g), 2-hydroxyethyl methacrylate (46.19 g), methacrylic acid (11.85 g) and glacial acrylic acid (35.53 g). When the kettle temperature reaches 89° C., a solution of ammonium persulfate (98%, 6.73 g) in DI water (18.88 g) is added to the kettle, followed by a DI water rinse (4.2 g). A BA/MMA/MAA latex seed having a particle size of 100 nm (37.37 g) is added followed by a DI water rinse (17.27 g). With the kettle temperature at 81-84° C., the monomer emulsion is fed to the kettle at 17.67 g/min over 15 min with the temperature set to 85° C. Simultaneously, a solution of ammonium persulfate (2.86 g) in DI water (97.39 g) is cofed at a rate of 0.606 g/min over 15 min. After 15 min, the monomer emulsion feed rate is increased to 35.33 g/min and the cofeed catalyst feed rate is increased to 1.212 g/min over 75 min. After 37-38 min from the start of feed, a BA/MMA/MAA latex seed having a particle size of 60 nm (57.8 g) is added to the kettle, followed by a DI water rinse (16.86 g). After 64-65 min from the start of feed, trimethoxyvinylsilane (98%, 6.02 g) and n-dodecyl mercaptan (98%, 1.18 g) are added to the monomer emulsion, followed by a DI water rinse (8.43 g). After completion of the additions of monomer emulsion and cofeed catalyst, followed by DI water rinse (84.6 g), the reaction mixture temperature is held at 85° C. for 15 min. After the hold, the kettle is cooled to 75° C. over 10 min. At 83° C., ammonium hydroxide solution (30%, 3.5 g) is added to the kettle, followed by DI water rinse (4.21 g). At 75° C., a solution of ferrous sulfate heptahydrate (0.15% solution, 10.2 g) is added to the kettle, followed by tert-butyl hydroperoxide (70% solution, 0.73 g) in DI water (8.43 g). A solution of Bruggolite FF6M (2.93 g) in DI water (44.6 g) is fed to the kettle at 1.058 over 45 min. After 15 min from the start of the reductant feed, tert-butyl hydroperoxide (70% solution, 3.70 g) in DI water (4.22 g) is added to the kettle. After completion of the Bruggolite FF6M solution, the reaction mixture is cooled to room temperature and filtered to remove any coagulum. A filtered product made by this process had a pH of 4.1, a solids content of 63.9%, and a viscosity of 256 cP (LV #2/60 rpm). DSC analysis afforded a midpoint of −45.9° C.; particle size analysis using capillary hydrodynamic fractionation (CHDF) technique indicated a particle size distribution based on weight area % of 421.4 nm (30%), 366.9 nm (66.4%), and 131.6 nm (3.6%).

### Polymer C

To a 5-L, four-necked round bottom flask (kettle) equipped with a paddle stirrer, thermometer, N2 inlet, and reflux condenser is added deionized water (DI) (443.59 g) and the kettle is heated to 89° C. under N2. A monomer emulsion is prepared by mixing DI water (504.56 g), sodium dodecyl benzene sulfonate (SDS, 22.5%, 31.59 g), butyl acrylate (2222.41 g), methyl methacrylate (47.4 g), 2-hydroxyethyl methacrylate (46.19 g), methacrylic acid (11.85 g) and glacial acrylic acid (35.53 g). When the kettle temperature reaches 89° C., a solution of ammonium persulfate (98%, 6.73 g) in DI water (18.88 g) is added to the kettle, followed by a DI water rinse (4.2 g). A BA/MMA/MAA latex seed having a particle size of 100 nm (37.37 g) is added followed by a DI water rinse (17.27 g). With the kettle temperature at 81-84° C., the monomer emulsion is fed to the kettle at 17.67 g/min over 15 min with the temperature set to 85° C. Simultaneously, a solution of ammonium persulfate (2.86 g) in DI water (97.39 g) is cofed at a rate of 0.606 g/min over 15 min. After 15 min, the monomer emulsion feed rate is increased to 35.33 g/min and the cofeed catalyst feed rate is increased to 1.212 g/min over 75 min. After 37-38 min from the start of feed, a BA/MMA/MAA latex seed having a particle size of 60 nm (57.8 g) is added to the kettle, followed by a DI water rinse (16.86 g). After 64-65 min from the start of feed, VTMS (98%, 6.01 g) and n-dodecyl mercaptan (98%, 1.18 g) are added to the monomer emulsion, followed by a DI water rinse (8.43 g). After completion of the additions of monomer emulsion and cofeed catalyst, followed by DI water rinse (84.6 g), the reaction mixture temperature is held at 85° C. for 15 min. After the hold, the kettle is cooled to 75° C. over 10 min. At 83° C., ammonium hydroxide solution (30%, 3.5 g) is added to the kettle, followed by DI water rinse (4.21 g). At 75° C., a solution of ferrous sulfate heptahydrate (0.15% solution, 10.2 g) is added to the kettle, followed by tert-butyl hydroperoxide (70% solution, 0.73 g) in DI water (8.43 g). A solution of Bruggolite FF6M (2.93 g) in DI water (44.6 g) is fed to the kettle at 1.058 over 45 min. After 15 min from the start of the reductant feed, tert-butyl hydroperoxide (70% solution, 3.7 g) in DI water (4.22 g) is added to the kettle. After completion of the Bruggolite FF6M solution, the reaction mixture is cooled to room temperature and filtered to remove any coagulum. A filtered product made by this process had a pH of 4.28, a solids content of 63.6%, and a viscosity of 213 cP (LV #2/60 rpm). DSC analysis afforded a midpoint of −42.92° C.; particle size analysis using capillary hydrodynamic fractionation (CHDF) technique indicated a particle size distribution based on weight area % of 420.2 nm (88.3%) and 145.9 nm (11.7%).

### Polymer D

The process is the same as the procedure described for Polymer C, except 1.39 g of MPTMS is used instead of 1.18 g of nDDM. The filtered product had a pH of 4.1, a solids content of 64.68%, and a viscosity of 234.7 cP (LV #2/60 rpm). DSC analysis afforded a midpoint of −40.95° C.; particle size analysis using capillary hydrodynamic fractionation (CHDF) technique indicated a particle size distribution based on weight area % of 84.5 nm (0.1%), 142.1 nm (3%), 392.6 nm (71.9%), and 458.8 nm (25%).

### Polymer E

The process is the same as the procedure described for Polymer B, except 6.08 g of VTES is used instead of 6.02 g of VTMS. The filtered product had a pH of 4.23, a solids content of 63.7%, and a viscosity of 181 cP (LV #2/60 rpm). DSC analysis afforded a midpoint of −48.03° C.; particle size analysis using capillary hydrodynamic fractionation (CHDF) technique indicated a particle size distribution based on weight area % of 465.4 nm (96.7%) and 638.4 nm (3.3%).

### Polymer F

The process is the same as the procedure described for Polymer C, but with the addition of 34.1 g of Tergitol 15-S-40 to the monomer emulsion at the start of feed and the addition of 6.01 g of MATS to the monomer emulsion after 64-65 min from the start of feed. The filtered product had a pH of 4.07, a solids content of 63.9%, and a viscosity of 208 cP (LV #2/60 rpm). DSC analysis afforded a midpoint of −42.07° C.; particle size analysis using capillary hydrodynamic fractionation (CHDF) technique indicated a particle size distribution based on weight area % of 455.3 nm (97.9%) and 630.9 nm (2.1%).

### Polymer G

The process is the same as the procedure described for Polymer B, but with the addition of 1.37 g of MPTMS instead of 1.18 g of nDDM. The filtered product had a pH of 4.02, a solids content of 64.19%, and a viscosity of 298.7 cP (LV #2/60 rpm). DSC analysis afforded a midpoint of −46.66° C.; particle size analysis using capillary hydrodynamic fractionation (CHDF) technique indicated a particle size distribution based on weight area % of 84.5 nm (0.1%), 132.6 nm (2.5%), 400.6 nm (78.3%), and 465.3 nm (19.1%).

### Polymer H

The process is the same as the procedure described for Polymer B, but with the addition of 6.01 g of VTMS to the monomer emulsion at the start of feed and 1.37 g of MPTMS instead of 1.18 g of nDDM. The filtered product had a pH of 3.94, a solids content of 64.16%, and a viscosity of 277.3 cP (LV #2/60 rpm). DSC analysis afforded a midpoint of −47.08° C.; particle size analysis using capillary hydrodynamic fractionation (CHDF) technique indicated a particle size distribution based on weight area % of 137.6 nm (3.3%), 370.1 nm (78.2%), 435 nm (33.1%), and 680.3 nm (0.7%).

### Polymer I (Comparative)

The process is the same as the procedure described for Polymer B, but with the addition of 6.08 g of VTMS to the monomer emulsion at the start of feed and only 1.18 g of nDDM added after 64-65 min from the start of feed. The filtered product had a pH of 3.97, a solids content of 64.79, and a viscosity of 288 cP (LV #2/60 rpm). DSC analysis afforded a midpoint of −45.62° C.; particle size analysis using capillary hydrodynamic fractionation (CHDF) technique indicated a particle size distribution based on weight area % of 74.9 nm (0.3%), 139.7 nm (3%), 369.5 nm (65.3%), and 437.1 nm (31.4%).

### Polymer J (Comparative)

The process is the same as the procedure described for Polymer C, but with 2230.29 g of BA and the addition of 34.1 g of Tergitol 15-S-40 and 3.64 g of MATS to the monomer emulsion at the start of feed. The filtered product had a pH of 3.8, a solids content of 65.38%, and a viscosity of 405.3 cP (LV #2/60 rpm). DSC analysis afforded a midpoint of −41.43° C.; particle size analysis using capillary hydrodynamic fractionation (CHDF) technique indicated a particle size distribution based on weight area % of 119.2 nm (0.7%), 180 nm (1.8%), 447.8 nm (80%), 543.3 nm (14.2%), 686.4 nm (2.4%), and 861.2 nm (0.9%).

Polymer K (Comparative-Single Stage, with No Chain Transfer Agent, 0.2Weight % Silane Monomer)

To a 5-L, four-necked round bottom flask (kettle) equipped with a paddle stirrer, thermometer, N2 inlet, and reflux condenser is added deionized water (DI) (565.80 g) and the kettle is heated to 89° C. under N₂. A monomer emulsion is prepared by mixing DI water (405.14 g), sodium dodecyl benzene sulfonate (SDS, 22.5%, 55.75 g), butyl acrylate (2331.44 g), glacial acrylic acid (84.36 g), and MATS (3.67 g). When the kettle temperature reaches 89° C., a solution of ammonium persulfate (98%, 0.68 g) in DI water (20.0 g) is added to the kettle, followed by a DI water rinse (7.1 g). A BA/MMA/MAA latex seed having a particle size of 100 nm (40.66 g) is added followed by a DI water rinse (22.1 g). With the kettle temperature at 81-84° C., the monomer emulsion is fed to the kettle at 12.31 g/min over 10 min with the temperature set to 85° C. Simultaneously, a solution of ammonium persulfate (1.73 g) in DI water (76.8 g) is cofed at a rate of 0.336 g/min over 10 min. After 10 min, the monomer emulsion feed rate is increased to 24.62 g/min and the cofeed catalyst feed rate is increased to 0.671 g/min over 112 min. After 68-69 min from the start of feed, a solution of SDS (43.7 g) and ammonia (30%, 3.2 g) in DI water (56.3 g) is added to the kettle, followed by a DI water rinse (10.0 g). Additional surfactants, SDS (28.01 g) and Triton X-405 (70%, 34.64 g), are then added to the monomer emulsion, followed by DI water rinses (22.1 g). After completion of the additions of monomer emulsion and cofeed catalyst, followed by DI water rinse (80.39 g), the reaction mixture temperature is cooled to 70° C. At 75° C., a solution of ferrous sulfate heptahydrate (0.15% solution, 1.67 g) is added to the kettle, followed by tert-butyl hydroperoxide (70% solution, 3.49 g) in DI water (4.53 g). A solution of sodium formaldehyde sulfoxylate (SSF/SFS, 1.75 g) in DI water (32.87 g) is fed to the kettle at 1.15 g/min over 30 min. After completion of the SFS solution, the reaction temperature is held at 56° C. for 15 min. After the hold, ammonia (30%, 4.97) is added to the kettle, followed by a DI water rinse (11.05 g). The reaction temperature is held for another 15 min. The reaction mixture is then cooled to room temperature and filtered to remove any coagulum. The filtered product had a pH of 6.09, a solids content of 63.0%, and a viscosity of 1621 cP (LV #3/60 rpm). DSC analysis afforded a midpoint of −41.03° C.; particle size analysis using capillary hydrodynamic fractionation (CHDF) technique indicated a particle size distribution based on weight area % of 81.4 nm (3.9%), 427.6 nm (94.5%), and 538.5 nm (1.6%).

The polymers B-J are summarized in the following Table 3. Note that all of polymers B-J had 0.2 weight % chain transfer agent in stage 2 only. All polymers B-J included 2 weight % MMA, 2 weight % HEMA, 0.5 weight % MAA, and 1.5 weight % AA in stage 1 and stage 2.

TABLE 3
Polymer Dispersion Compositions and Characterization Data

| | | | | Wt. % silane | Wt. % silane | |
|---|---|---|---|---|---|---|
| | Silane Monomer | Chain Transfer | EHA | monomer is | monomer in | Tg |
| Polymer | used | Agent used | (yes/no) | stage 1 | stage 2 | (° C.) |
| B | VTMS | nDDM | Yes | 0 | 0.9 | −45.89 |
| C | VTMS | nDDM | No | 0 | 0.9 | −42.92 |
| D | None | MPTMS | No | — | — | −40.95 |
| E | VTES | nDDM | Yes | 0 | 0.9 | −48.03 |
| F | MATS | nDDM | No | 0 | 0.9 | −42.07 |
| G | VTMS | MPTMS | Yes | 0 | 0.9 | −46.66 |
| H | VTMS | MPTMS | Yes | 0.2 | 0.2 | −47.08 |
| I | VTMS | nDDM | Yes | 0.3 | 0.3 | −45.62 |
| (Comparative) | | | | | | |
| J | MATS | nDDM | No | 0.2 | 0.1 | −41.43 |
| (Comparative) | | | | | | |

### Sealant Formulation Procedure:

All sealants were prepared on an approximately 1.5 liter scale in the Ross planetary mixer (Charles Ross & Son Company, Hauppauge, NY 11788). Raw materials were added in a sequential order based on the formulation in Table 4 below and mixed for 30 minutes under vacuum of at least −25 inches of mercury (−85 kilopascals).

TABLE 4
Sealant Formulation with P/B 0.05

| Ingredient Type | SI Units | |
|---|---|---|
| Polymer | kg/100 L | 82.59 |
| dispersion at 62- | | |
| 64% solids | | |
| Water | kg/100 L | 5.77 |
| Triton X-405 | kg/100 L | 0.94 |
| Ethylene Glycol | kg/100 L | 1.67 |
| Tylose HS | kg/100 L | 1.06 |
| 100000 YP2 | | |
| Kathon LX 1.5% | kg/100 L | 0.07 |
| Skane M-8 | kg/100 L | 0.06 |
| Semtol 500 | kg/100 L | 5.67 |
| White Mineral | | |
| Oil | | |
| Momentive A- | kg/100 L | 0.24 |
| 187 Silane | | |
| Ti-Pure R-900 | kg/100 L | 1.19 |
| CAB-O-SIL M-5 | kg/100 L | 1.43 |
| Ammonia (28%) | kg/100 L | 0.52 |
| Calculations | | |
| Solids, Wt %: | | 58.8 |
| Solids, Vol %: | | 60.0 |
| Pigment/Binder | | 0.05 |
| Ratio: | | |

### Inventive Examples 1-7 (IE1-IE7) and Comparative Examples 1-4 (CE1-CE4)

Sealant compositions were formulated as set forth above and then tested for Joint Movement Capability and Wet Peel Adhesion as described above. The results are shown in Tables 5 and 6.

TABLE 5
Joint Movement Capability based on ASTM C719 (SI units)

| | | Sample ID | | | | | | | | | | |
|---|---|---|---|---|---|---|---|---|---|---|---|---|
| | | IE1 | IE2 | IE3 | IE4 | IE5 | IE6 | IE7 | CE1 | CE2 | CE3 | CE4 |
| | | Polymer | | | | | | | | | | |
| Substrate | Temperature | B | C | D | E | F | G | H | A | I | J | K |
| Glass | Room | Pass, | Pass, | Pass, | — | — | — | — | Fail, | Pass, | Pass | Fail, |
| | temperature | 4 C | 2 C | 4 C | | | | | 12.9 C | NF | 1.6 C | 19.4 C |
| Aluminum | Room | Pass, | Pass, | Pass, | Pass, | Pass, | Pass, | Pass, | Fail, | Fail, | Fail, | Fail, |
| | temperature | 0.8 C | 0.4 C | 1.2 C/A | 2.4 C | 2 C | 2 C | 2.8 C | all C | 16.1 C | 19.4 A | 19.4 A |
| Mortar | Room | Pass, | Pass, | Pass, | — | — | — | — | Fail, | Fail, | Pass, | Fail, |
| | temperature | 4.8 C | 4.8 C | 1.6 C, A | | | | | 16 C | 10.3 C | 2.4 C | 11 C |
| Glass | −26° C. | Pass, | Pass, | Pass, | — | — | — | — | n/a | Pass, | Pass, | n/a |
| | | 2.4 C | 2.4 C | 2 C | | | | | | 0.4 C | 2 C | |
| Aluminum | −26° C. | Pass, | Pass, | Pass, | Pass, | Pass, | Pass, | Pass, | n/a | n/a | n/a | n/a |
| | | 2.4 C | 2.4 C | 1.6 C, | 2.4 C | 2 C | 2.4 C | 4.4 C, | | | | |
| | | | | 0.8 A | | | | 1.6 A | | | | |
| Mortar | −26° C. | Pass, | Pass, | Pass, | — | — | — | — | n/a | n/a | Pass, | n/a |
| | | 6.5 C | 6.5 C | 3.6 C | | | | | | | 4.8 C | |

Notes
Failure Modes: A = Adhesive, C = Cohesive, NF = No Failure
The number indicates centimeters squared of adhesive/cohesive failure.
Cure for joint movement = 1 week CTR (constant temp/humidity room), 2 weeks 50° C.

TABLE 6
Wet Peel Adhesion ASTM C794

| | Sample ID | | | | | | |
|---|---|---|---|---|---|---|---|
| | IE2 | IE2 | IE3 | CE1 | CE2 | CE3 | CE4 |
| | Polymer | | | | | | |
| Substrate | B | C | D | A | I | J | K |
| Glass | Pass | Pass | Fail | Fail | Pass | Pass | Pass |
| | 44-58 N | 44-58 N | 58-76 N | 36-44 N | 44-58 N | 53-76 N | 40-49 N |
| | C, A (25%) | C, A (25%) | C, A (30%) | C, A (50%) | C | C | C, A (20%) |
| Aluminum | Pass | Pass | Pass | Pass | Fail | Fail | Fail |
| | 49-89 N | 49-76 N | 62-85 N | 44 N | 27-53 N | 20 N | 11 N |
| | C | C | C, A (15%) | C | C, A (75%) | A | A |
| Mortar | Pass | Pass | Pass | Pass | Pass | Fail | Fail |
| | 49-67 N | 58-85 N | 67-89 N | 40-49 N | 49-58 N | 40-67 N | 13-36 N |
| | C | C, A (20%) | C | C | C, A (10%) | C, A(50%) | C, A (70%) |

Failure Modes: A = Adhesive, C = Cohesive,
Data: 1) Pass/Fail, 2) Force in Newtons, 3) failure mode (% adhesive failure)

This disclosure further encompasses the following aspects.

Aspect 1: An aqueous composition comprising (a) an aqueous polymer dispersion comprising water and at least 50, preferably 50-80, weight % polymer particles based on total weight of the aqueous polymer dispersion where the polymer particles are made by polymerizing, in a first stage, monomers comprising 85 to 99, preferably 90-98.5 weight % non-ionic ethylenically unsaturated monomers and 1 to 15, preferably 1.5 to 10 weight % of ethylenically unsaturated acid functional monomers, where the weight % for each is based on total weight of monomers in the first stage to form a first stage polymer followed by continuing polymerizing, in a second stage, reactants comprising 85 to 98.5 weight % non-ionic ethylenically unsaturated monomers, 1 to 15 weight % of ethylenically unsaturated acid functional monomers, and either (i) 0.01 to 0.5 weight % a non-silane functional chain transfer agent and 0.4 to 2 weight % of an ethylenically unsaturated silane functional monomer or (ii) 0.01 to 0.5 weight % of a silane functional chain transfer agent and 0 to 2 weight % of an ethylenically unsaturated silane functional monomer to form a second stage polymer, wherein the weight ratio of the first stage to the second stage is 1:1 to 9:1, and (b) filler and/or pigment, wherein the weight ratio of filler to polymer particles is 0.01:1 to 2:1 preferably 0.02:1 to 1:1, more preferably 0.02:1 to 0.5:1.

Aspect 2: The composition of Aspect 1 wherein at least 90% of the monomers in the first stage have a Fox Tg of less than −20° C.

Aspect 3: The composition of Aspect 1 or 2 wherein the first stage polymer has a calculated glass transition temperature of −60 to −30° C.

Aspect 4: The composition of any one of the preceding Aspects wherein the polymer has a Tg according to DSC of −60 to −30° C.

Aspect 5. The composition of any one of the preceding Aspects wherein the chain transfer agent comprises a non-silane functional mercaptan functional compound.

Aspect 6: The composition of Aspect 5 wherein the non-silane functional mercaptan compound is selected from-dodecyl mercaptan (nDDM), tert-dodecyl mercaptan, methyl-3-mercaptopropionate, butyl-3-mercaptopropionate, i-octyl-3-mercaptopropionate, i-decly-3-mercaptopropionate, dodecyl-3-mercaptopropionate, octadecyl-3-mercaptopropionate, 2-ethyl hexyl-3-mercaptopropionate, and mercaptopropionic acid preferably is n-dodecyl mercaptan.

Aspect 7: The composition of any one of the preceding Aspects wherein the chain transfer agent comprises a silane functional chain transfer agent.

Aspect 8. The composition of Aspect 7 wherein the silane functional chain transfer agent has the formula: formula Z—CH₂CH₂CH₂—Si(—OR)₃₋ₓ(—Me)ₓ, wherein Z is an unbranched or branched, or linear aliphatic hydrocarbon with a heteroatom such as O, N or S. Z is a mercapto (—SH); R is either a branched or linear alkyl group of 1 to 18, preferably 1 to 5 carbon atoms, preferably selected from methyl, ethyl, propyl, isopropyl, butyl and tert-butyl; and x is an integer from 0 to 3.

Aspect 9: The composition of any one of the preceding Aspects wherein the ethylenically unsaturated silane monomer has the formula: R′—Si(—OR)₃₋ₓ(—Me)ₓ, wherein R′ represents a functional group selected from any substituted or unsubstituted, ethylenically unsaturated hydrocarbyl group, preferably of 2 to 3 carbon atoms, and R is either a branched or linear alkyl group of 1 to 18, preferably 1 to 5 carbon atoms, preferably selected from methyl, ethyl, propyl, isopropyl, butyl and tert-butyl; and x is an integer from 0 to 3.

Aspect 10: The composition of any one of the preceding Aspects wherein the ethylenically unsaturated silane monomer is selected from vinyltrimethoxy silane, vinyltriethoxy silane, or trimethoxysilyl propyl methacrylate or combinations thereof.

Aspect 11: The composition of any one of the preceding Aspects wherein the non-ionic ethylenically unsaturated monomer is selected from alkyl acrylates; alkyl methacrylates; hydroxy substituted alkyl acrylates; hydroxy substituted alkyl methacrylates; styrenic monomers or combinations thereof.

Aspect 12: The composition of any one of the preceding Aspects wherein the ethylenically unsaturated acid monomer is selected ethylenically unsaturated carboxylic acid functional monomers, ethylenically unsaturated sulfur acid functional monomers, ethylenically unsaturated phosphorous acid functional monomers, or combinations thereof, preferably ethylenically unsaturated carboxylic acid functional monomers and more preferably acrylic acid, methacrylic acid or combinations thereof.

Aspect 13: The composition of any one of the preceding Aspects wherein the filler comprises one or more of alkaline earth metal sulfates or carbonates; silicates; metal oxides and hydroxides; diatomaceous earth; colloidal silica; fumed silica; carbon black; white carbon black; nutshell flour; natural and synthetic fibers; and scrap or recycled plastics in the form of dust, flakes or flour; hollow or solid ceramic, glass or polymeric microspheres.

Aspect 14: The composition of any one of the preceding Aspects wherein the first stage comprises 50-90 weight percent of the polymer and the second stage comprises 10-50 weight percent of the polymer.

Aspect 15: The composition of any one of the preceding Aspects further comprising one or more of adhesion promoter, solvent, surfactant, emulsifier, freeze-thaw stabilizers, drying oils, biocides, rheology modifiers or thickeners, defoamer, dyes, waxes and anti-oxidants.

Aspect 16: The composition of any one of the preceding Aspects which provides less than 9 cm² bond loss joint movement capability pursuant to ASTM C719 at 50% compression and extension for 10 cycles on glass substrates, on aluminum substrates, and/or concrete mortar substrates, preferably at −26° C.

Aspect 17: The composition of any one of the preceding Aspects which when applied and dried meets the requirements of ASTM C920 class 50 sealant.

Aspect 18: A sealant comprising a two stage silane functionalized acrylic copolymer and a filler wherein the weight ratio of filler to polymer particles is 0.01:1 to 2:1 characterized by less than 9 cm² bond loss joint movement capability pursuant to ASTM C719 at 50% compression and extension for 10 cycles on glass, aluminum or concrete mortar substrates, preferably at −26° C.

Aspect 19: A sealant comprising a two stage silane functionalized acrylic copolymer and a filler wherein the weight ratio of filler to polymer particles is 0.01:1 to 2:1 characterized by meeting the requirements of an ASTM C920 class 50 sealant.

Aspect 20: A method comprising applying the composition of any one of Aspects 1-17 to a substrate and drying to form a sealant that meets ASTM C920 class 50 requirements.

All ranges disclosed herein are inclusive of the endpoints, and the endpoints are independently combinable with each other (e.g., ranges of “up to 25 wt. %, or, more specifically, 5 wt. % to 20 wt. %”, is inclusive of the endpoints and all intermediate values of the ranges of “5 wt. % to 25 wt. %,” etc.). Moreover, stated upper and lower limits can be combined to form ranges (e.g., “at least 1 or at least 2 weight %” and “up to 10 or 5 weight %” can be combined as the ranges “1 to 10 weight %”, or “1 to 5 weight %” or “2 to 10 weight %” or “2 to 5 weight %”).

The disclosure may alternately comprise, consist of, or consist essentially of, any appropriate components herein disclosed. The disclosure may additionally, or alternatively, be formulated so as to be devoid, or substantially free, of any components, materials, ingredients, adjuvants or species used in the prior art compositions or that are otherwise not necessary to the achievement of the function and/or objectives of the present disclosure.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

Unless specified to the contrary herein, all test standards are the most recent standard in effect as of the filing date of this application, or, if priority is claimed, the filing date of the earliest priority application in which the test standard appears.

1. An aqueous composition comprising
(a) an aqueous polymer dispersion comprising water and at least 50 weight % polymer particles based on total weight of the aqueous polymer dispersion where the polymer particles are made by polymerizing, in a first stage, monomers comprising 85 to 99 weight % non-ionic ethylenically unsaturated monomers and 1 to 15 weight % of ethylenically unsaturated acid functional monomers, where the weight % for each is based on total weight of monomers in the first stage to form a first stage polymer followed by continuing polymerizing, in a second stage, reactants comprising 85 to 98.5 weight % non-ionic ethylenically unsaturated monomers, 1 to 15 weight % of ethylenically unsaturated acid functional monomers, and either (i) 0.01 to 0.5 weight % a non-silane functional chain transfer agent and 0.4 to 2 weight % of an ethylenically unsaturated silane functional monomer or (ii) 0.01 to 0.5 weight % of a silane functional chain transfer agent and 0 to 2 weight % of an ethylenically unsaturated silane functional monomer to form a second stage polymer, wherein the weight ratio of the first stage to the second stage is 1:1 to 9:1, and (b) filler and/or pigment, wherein the weight ratio of filler to polymer particles is 0.01:1 to 2:1.

2. The composition of claim 1 characterized by one or more of the following:
at least 90% of the monomers in the first stage have a Fox Tg of less than −20° C.;
the first stage polymer has a calculated glass transition temperature of −60 to −30° C.;
the polymer has a Tg according to DSC of −60 to −30° C.

3. The composition of claim 1 wherein the chain transfer agent comprises n-dodecyl mercaptan.

4. The composition of claim 1 wherein the chain transfer agent comprises a silane functional chain transfer agent.

5. The composition of claim 4 wherein the silane functional chain transfer agent has the formula: formula Z—CH₂CH₂CH₂—Si(—OR)₃₋ₓ(—Me)ₓ, wherein Z is an unbranched or branched, or linear aliphatic hydrocarbon with a heteroatom such as O, N, or S; Z is a mercapto (—SH); R is either a branched or linear alkyl group of 1 to 18 carbon atoms; and x is an integer from 0 to 3.

6. The composition of claim 1 wherein the ethylenically unsaturated silane monomer has the formula: R′—Si(—OR)₃₋ₓ(—Me)ₓ, wherein R′ represents a functional group selected from any substituted or unsubstituted, ethylenically unsaturated hydrocarbyl group, preferably of 2 to 5 carbon atoms, and R is either a branched or linear alkyl group of 1 to 18; and x is an integer from 0 to 3.

7. The composition of claim 6 wherein the ethylenically unsaturated silane monomer is selected from vinyltrimethoxy silane, vinyltriethoxy silane, or trimethoxysilyl propyl methacrylate or combinations thereof.

8. The composition of claim 1 wherein the non-ionic ethylenically unsaturated monomer is selected from alkyl acrylates, alkyl methacrylates, hydroxy substituted alkyl acrylates, hydroxy substituted alkyl methacrylates, styrenic monomers, or combinations thereof.

9. The composition of claim 1 wherein the ethylenically unsaturated acid monomer is selected ethylenically unsaturated carboxylic acid functional monomers, ethylenically unsaturated sulfur acid functional monomers, ethylenically unsaturated phosphorous acid functional monomers, or combinations thereof.

10. The composition of claim 1 wherein the filler comprises one or more of alkaline earth metal sulfates or carbonates; silicates; metal oxides and hydroxides; diatomaceous earth; colloidal silica; fumed silica; carbon black; white carbon black; nutshell flour; natural and synthetic fibers; and scrap or recycled plastics in the form of dust, flakes or flour; hollow or solid ceramic, glass or polymeric microspheres.

11. The composition of claim 1 further comprising one or more of adhesion promoter, solvent, surfactant, emulsifier, freeze-thaw stabilizers, drying oils, biocides, rheology modifiers or thickeners, defoamers, dyes, waxes and anti-oxidants.

12. A sealant comprising a two stage silane functionalized acrylic copolymer and a filler wherein the weight ratio of filler to polymer particles is 0.01:1 to 2:1 characterized by
(a) less than 9 cm² bond loss joint movement capability pursuant to ASTM C719 at 50% compression and extension for 10 cycles on glass, aluminum or concrete mortar substrates and/or (b) meeting the requirements of an ASTM C920 class 50 sealant.

13. A method comprising applying the composition of claim 1 to a substrate and drying to form a sealant that meets ASTM C920 class 50 requirements.

14. The composition of claim 6 wherein R′ represents a functional group selected from any substituted or unsubstituted, ethylenically unsaturated hydrocarbyl group having 2 to 5 carbon atoms.
